(19) United States
(12) Patent Application Publication
(10) Pub. No.: US 2006/0048123 A1
(43) Pub. Date: Mar. 2, 2006

(54) Modification of swing modulo scheduling to reduce register usage

(75) Inventor: Allan Russell Martin, Toronto (CA)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/930,039

(22) Filed: Aug. 30, 2004

(51) Int. Cl. G06F 9/45

(52) U.S. Cl. 717/160

(57) ABSTRACT

A method, apparatus, and computer instructions for optimizing loops in code during swing modulo scheduling of the code. Nodes in the data dependency graph are given a prioritized ordering for placement, using height/depth as the primary prioritization characteristic. When a node is selected with highest priority based on height/depth the node is then tested to see if it has significant slack, in which case a determination is made if there are any available nodes that lie on the critical path. Nodes from the critical path are thus taken as higher priority than nodes with significant slack, and are placed earlier in the prioritized ordering.

### CROSS REFERENCE TO RELATED APPLICATIONS

The present invention is related to an application entitled Extension of Swing Modulo Scheduling to Evenly Distribute Uniform Strongly Connected Components, attorney docket no. CA920040082US1, filed even date hereof, assigned to the same assignee, and incorporated herein by reference.

### BACKGROUND OF THE INVENTION

1. Technical Field

The present invention relates generally to an improved data processing system and in particular to a method and apparatus for processing data. Still more particularly, the present invention relates to a method, apparatus, and computer instructions for optimizing code.

2. Description of Related Art

Software pipelining is a compiler optimization technique for reordering hardware instructions within a given loop of a computer program being compiled, so as to minimize the number of cycles required to execute each iteration of the loop. More specifically, software pipelining attempts to optimize the scheduling of such hardware instructions by overlapping the execution of instructions from multiple iterations of the loop.

For the purposes of the present discussion, it may be helpful to introduce some commonly used terms in software pipelining. As well known in the art, individual machine instructions in a computer program may be represented as “nodes” having assigned node numbers, and the dependencies and latencies between the various instructions may be represented as “edges” between nodes in a data dependency graph (“DDG”). A grouping of related instructions, as represented by a grouping of interconnected nodes in a data dependency graph, is commonly known as a “sub-graph”. If the nodes of one sub-graph have no dependencies on nodes of another sub-graph, these two sub-graphs may be said to be “independent” of each other.

Software pipelining techniques may be used to attempt to optimally schedule the nodes of the sub-graphs found in a data dependency graph. A well known technique for performing software pipelining is “modulo scheduling”. Based on certain calculations, modulo scheduling selects a likely minimum number of cycles that the loops of a computer program will execute in, usually called the initiation interval (“II”), and attempts to place all of the instructions into a schedule of that size. Using this technique, instructions are placed in a schedule consisting of the number of cycles equal to the initiation interval. If, while scheduling, some instructions do not fit within initiation interval cycles, then these instructions are wrapped around the end of the schedule into the next iteration, or iterations, of the schedule. If an instruction is wrapped into a successive iteration, the instruction executes and consumes machine resources as though it were placed in the cycle equal to a placed cycle % (modulo operator) initiation interval.

Thus, for example, if an instruction is placed in cycle “10”, and the initiation interval is 7, then the instruction would execute and consume resources at cycle “3” in another iteration of the scheduled loop. When some instructions of a loop are placed in successive iterations of the schedule, the result is a schedule that overlaps the execution of instructions from multiple iterations of the original loop. If the scheduling fails to place all of the instructions for a given initiation interval, the modulo scheduling technique iteratively increases the initiation interval of the schedule and tries to complete the schedule again. This is repeated until the scheduling is completed.

Swing modulo scheduling (SMS) is a known modulo scheduling technique designed to improve upon other known modulo scheduling techniques in terms of the number of cycles, length of the schedule, and registers used. More information on swing modulo scheduling may be found in Llosa et al., Lifetime-Sensitive Modulo Scheduling in a Production Environment, IEEE Transactions on Computers, vol. 50, no. 3, March 2001, pp. 234-249. Swing modulo scheduling has some distinct features. For example, swing modulo scheduling allows scheduling of instructions (i.e. nodes in a data dependency graph) in a prioritized order, and it allows placement of the instructions in the schedule to occur in both “forward” and “backward” directions.

Swing modulo scheduling includes three basis steps. The first step is to build a data dependency graph. Then, the nodes in the graph are ordered. The third step involves scheduling of the nodes.

One problem that often occurs when scheduling loops in complex data dependency graphs is that a schedule is found that requires more registers than are available on a given processor. As a result, a less optimal schedule may be generated.

A number of known approaches are present for handling loops that are register-constrained. These approaches include generating spill instructions that store and retrieve register values to and from memory. Another approach involves increasing the initiation interval of the loop and trying to find a new schedule that requires fewer registers. These types of optimizations, however, result in schedules that have increased memory traffic caused by extra load/store instructions and/or require a greater number of cycles to execute than an optimal schedule.

As a result, the currently used swing modulo scheduling process is sometimes unable to find an optimal schedule in terms of the initiation interval and the amounts of memory traffic. Therefore, it would be advantageous to have an improved method, apparatus, and computer instructions for scheduling instructions to generate desired and optimal schedules.

### SUMMARY OF THE INVENTION

The present invention provides a method, apparatus, and computer instructions for optimizing loops in code during swing modulo scheduling of the code. Nodes in the data dependency graph are given a prioritized ordering for placement, using height/depth as the primary prioritization characteristic. When a node is selected with highest priority based on height/depth the node is then tested to see if it has significant slack, in which case a determination is made if there are any available nodes that lie on the critical path. Nodes from the critical path are thus taken as higher priority than nodes with significant slack, and are placed earlier in the prioritized ordering.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented;

FIG. 3 is a diagram of components used in compiling software in accordance with a preferred embodiment of the present invention;

FIG. 4 is a flowchart of a process for generating code in accordance with a preferred embodiment of the present invention;

FIG. 5 is a flowchart of a process for performing swing modulo scheduling in accordance with a preferred embodiment of the present invention;

FIG. 6 is a flowchart of a process for ordering nodes in accordance with a preferred embodiment of the present invention;

FIG. 7 is a flowchart of a process for identifying a registered constrained loop in accordance with a preferred embodiment of the present invention;

FIG. 8 is a data dependency graph in accordance with a preferred embodiment of the present invention;

FIG. 9 is a schedule generated by a known swing modulo scheduling algorithm;

FIG. 10 is a diagram illustrating scheduling of nodes from a data dependency graph in accordance with a preferred embodiment of the present invention;

FIG. 11 is a data dependency graph in accordance with a preferred embodiment of the present invention;

FIG. 12 is a diagram illustrating properties of nodes in a data dependency graph in accordance with a preferred embodiment of the present invention;

FIG. 13 is a diagram illustrating a schedule generated through a known swing modulo scheduling algorithm;

FIG. 14 is a live register table from the schedule in FIG. 13;

FIG. 15 is a diagram illustrating a schedule using an ordering process of the present invention; and

FIG. 16 is a live register table based on the schedule in FIG. 15 in accordance with a preferred embodiment of the present invention.

### DETAILED DESCRIPTION OF THE PREFERRED EMBODIMENT

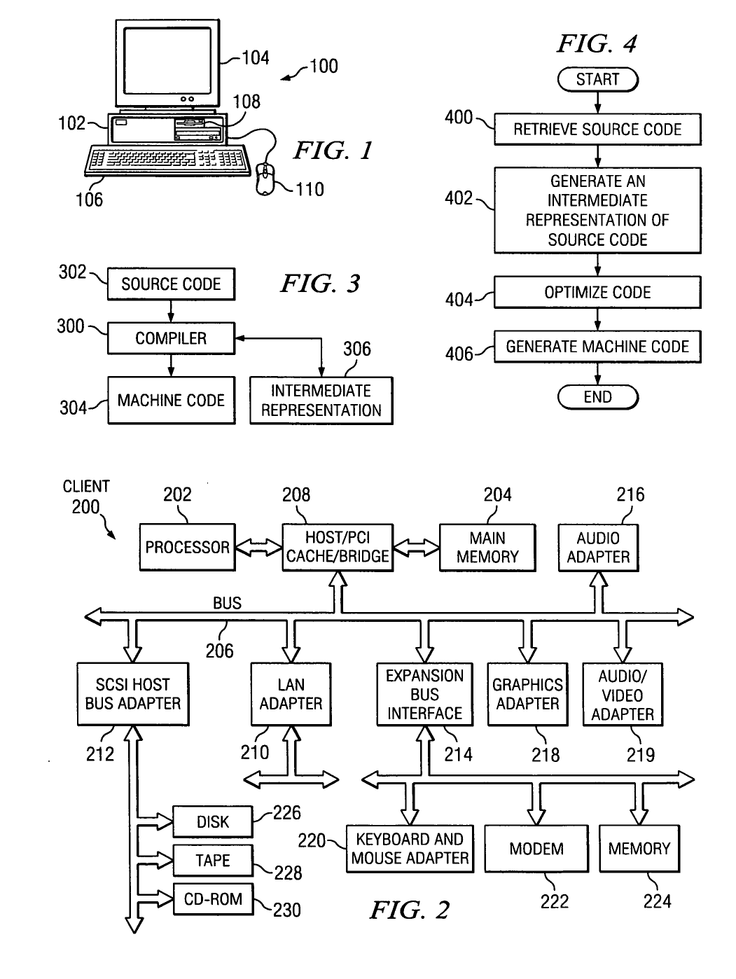

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eserver computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in connectors.

In the depicted example, local area network (LAN) adapter 210, small computer system interface (SCSI) host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows XP, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more peripheral devices 226-230.

Turning next to FIG. 3, a diagram of components used in compiling software is depicted in accordance with a preferred embodiment of the present invention. Compiler 300 is software used to generate code for execution from code in a high-level language. Compiler first converts a set of high-level language statements into a lower-level representation. In this example, the higher-level statements are present in source code 302. Source code 302 is written in a high-level programming language, such as, for example, C and C++. Source code 302 is converted into machine code 304 by compiler 300.

In the process of generating machine code 304 from source code 302, compiler 300 creates intermediate representation 306 from source code 302. Intermediate representation 306 code is processed by compiler 300 during which optimizations to the software may be made. After the optimizations have occurred, machine code 304 is generated from intermediate representation 306.

The present invention provides a method, apparatus, and computer instructions for scheduling execution of instructions in code to optimize execution of the code. In these illustrative examples, software pipelining is a compiler optimization technique for reordering instructions within a given loop in a program being compiled to minimize the number of processor cycles required for the execution of each iteration of the loop. More specifically, software pipelining optimizes execution of code through overlapping the execution of different iterations of the loop. The mechanism of the present invention may be implemented as a process as a compiler, such as compiler 300 in FIG. 3.

Turning now to FIG. 4, a flowchart of a process for generating code is depicted in accordance with a preferred embodiment of the present invention. The process illustrated in FIG. 4 may be implemented in a compiler, such as compiler 300 in FIG. 3.

The process begins by receiving source code (step 400). An intermediate representation of the source code is generated (step 402). Optimizations of the intermediate representation of the source code are performed (step 404). These optimizations may include, for example, optimizing scheduling of the execution of instructions. Machine code is then generated (step 406) with the process terminating thereafter.

The mechanism of the present invention may be implemented within step 404 in FIG. 4 as a part of the optimizations performed on the code. The mechanism of the present invention is based on swing modulo scheduling and modifies this scheduling system to identify strongly connected components in a data dependency graph. The mechanism of the present invention may perform loop unrolling and is designed to handle cases in which some remaining dependency between unrolled iterations of the loop are present. The dependencies that remain may form a strongly connected component (SCC).

A strongly connected component contains nodes that have a cyclic data dependency. For example, if node A leads to node B and node B leads back node A then a cyclic dependency is present. Since unrolled iterations of the loop comprise the same instruction sequence in a strongly connected component, a strongly connected component that connects the unrolled iterations will likely include a repeating pattern of instructions. This type of strongly connected component is called a uniform strongly connected component.

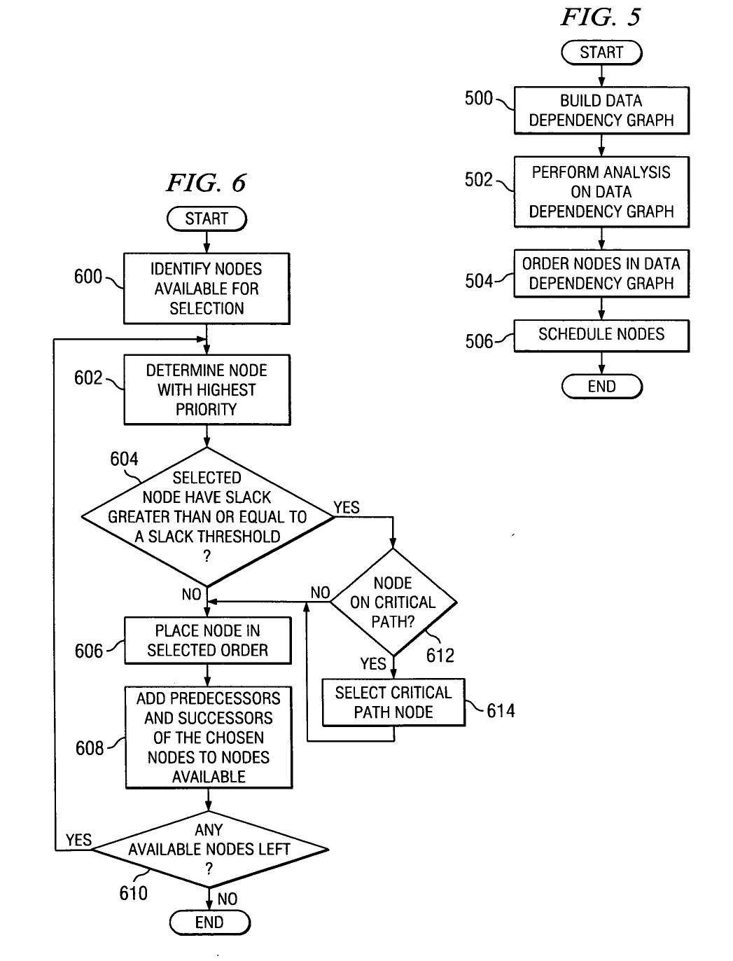

Turning now to FIG. 5, a flowchart of a process for performing swing modulo scheduling is depicted in accordance with a preferred embodiment of the present invention. This process is performed by a compiler, such as compiler 300 in FIG. 3. The mechanism of the present invention may be implemented within this process in these illustrative examples.

The process begins by building a data dependency graph (step 500). Next, an analysis is performed on the data dependency graph (step 502). This analysis includes, for example, calculating the height, depth, earliest time, latest time, and slack for each node in the graph. Slack is a means or mechanism for tolerating uncertainties in schedules. In these examples, slack is the difference between the latest time and the earliest time. Slack indicates how much freedom is present in the schedule for a node to be placed in the schedule while respecting all latencies for predecessor and successor nodes. In these examples, the nodes correspond to instructions. Significant slack for a given node is defined as slack that is greater than or equal to a selected threshold.

Next, the nodes in the data dependency graph are ordered (step 504). The ordering in step 504 is performed based on the priority given to groups of nodes, such that the ordering always grows out from a nucleus of nodes rather than starting two groups of nodes and connecting them together. A feature of this step is that the direction of ordering works in both the forward and backward direction, so that nodes are added to the order that are both predecessors and successors of the nucleus of previously ordered nodes.

When considering the first node or when an independent section of the data dependency graph is finished, the next node to be ordered is selected from the pool of unordered nodes based on its priority (using minimum earliest time for forward direction and maximum latest time for backward direction). Then, nodes that are predecessors and successors to the pool of previously ordered nodes are considered available for ordering. Swing modulo scheduling selects the highest priority node based on largest height/depth in the respective forward/backward direction as the primary characteristic, and lowest slack as the secondary characteristic. The result is that whenever possible, nodes that are added only have predecessors or successors already ordered, not both.

At all times during the ordering phase of swing modulo scheduling, there exists a list of nodes that have been placed in the schedule, and a list of nodes that are available to be placed into the schedule next. There also exist nodes that have not been placed yet, and are not yet available for ordering. Once a new node is selected as the highest priority among the available nodes, it is added to the list of nodes in the ordering. Once it is added, then all predecessors and successors of this node are now available for ordering, as long as they are not yet ordered and were not previously available for ordering. In this way, the ordering of nodes grows outward from the list of nodes that have been ordered.

After the nodes are ordered, the ordered nodes are scheduled for execution (step 506) with the process terminating thereafter. This step looks at the nodes in the order set from step 504 of the algorithm, and places a node as close as possible (while respecting scheduling latencies) to its predecessors and successors. Again, because the order selected in step 502 can change direction freely between moving forward and backward, the scheduling step is performed in the forward and backward direction, placing nodes such that the nodes are in an appropriate number of cycles before successors or after predecessors.

The present invention provides an improved method, apparatus, and computer instructions for scheduling the execution of instructions. The mechanism of the present invention may be implemented as part of the ordering phase of a swing modulo scheduling process. The present invention recognizes that the current swing modulo scheduling process uses a fundamental ordering algorithm that favors nodes that are not on the critical path of the data dependency graph over nodes that are on the critical path and are near the top or bottom of the data dependency graph.

The current swing modulo system ordering algorithm uses this type of bias to attempt to avoid generating an order whenever possible where a node has both predecessors and successors previously ordered. The present invention recognizes that this property of the currently used swing modulo scheduling ordering algorithm leads to a less than optimal schedule in certain situations where more registers are needed than are available.

The mechanism of the present invention modifies this ordering algorithm in the swing modulo scheduling process when a register-constrained loop is encountered in the scheduling process. A register-constrained loop is a loop in which the number of registers available is limited. In the event that scheduling of a register-constrained loop is present, nodes on the critical path of the data dependency graph are favored over nodes that are not on the critical path. In these examples, the critical path is the longest path in the data dependency graph. The length of the path is not based on the number of nodes, but is based on the latency of the nodes. Therefore, the longest path in the data dependency graph is the path through a set of nodes that has the longest latency.

As a result, the mechanism of the present invention is in contravention and opposite to the fundamental rules of the ordering phase in currently used swing modulo scheduling processes. This opposite favoring of nodes allows for priority to be given to nodes on the critical path. Further, this mechanism does not require the calculation of any additional information about the data dependency graph. The mechanism of the present invention allows for schedules to be found for loops with a shorter overall duration. In turn, this shorter duration leads to low register usage. With loops that are register-constrained, the mechanism of the present invention can generate schedules that are optimal in the number of cycles and register usage. This type of scheduling is not possible with the current swing modulo scheduling quartering algorithm.

The mechanism of the present invention gives priority to critical paths in which priority is based on height/depth. Specifically, the mechanism of the present invention uses ordering heuristics in which slack is the primary factor and height/depth is a secondary factor, except when the highest priority node has significant slack and a critical path node is available. In this case, the node on the critical path is selected for placement. Thus, if a critical path node is selected over a node with significant slack, the critical path node will be placed in the ordering and the node with slack will be inserted someplace later in the prioritized ordering, which means it is a lower priority.

Another currently known process prioritizes nodes, but in a different manner. Llosa et al., Reduced Code Size Modulo Scheduling in the Absence of Hardware Support, 35^{th} Annual IEEE/ACM International Symposium on Microarchitecture (MICRO-35), 18-22 Nov. 2002, Istanbul, Turkey, pp. 1-24 is an article that describes using critical paths. This article however, performs this ordering using different priorities. In this article, an Lx compiler's modulo scheduler (LxMS) is described.

LxMS prioritizes nodes using minimum slack as the primary heuristic, and uses height/depth as a secondary heuristic when multiple available nodes have equally low slack. However, this process treats nodes that have both predecessors and successors on the critical path specially, so that for these nodes this process uses height/depth as the primary characteristic. This means that for loops in which there lies a long critical path, and there exists a non-critical path node that has significant slack and it has both predecessors and successors on the critical path, then it will give this node a higher priority than its critical path successor in the forward direction, or its predecessor in the backward direction. This type of ordering is different from that in the mechanism of the present invention, which would give priority to the critical path nodes. Also, LxMS will differ from the mechanism of the present invention in that LxMS will give priority to a chain of critical path nodes over a chain of non-critical path nodes in the case where they have a very small but non-zero slack value. This could lead to a situation where it is impossible to place the non-critical path nodes. The mechanism of the present invention, however, gives priority based on height/depth, likely alternating between the critical path and non-critical path nodes, to avoid the difficulty.

In summary, LxMS uses different ordering heuristics than the invention: it uses lowest slack as primary and greatest height/depth as secondary, with an exception for non-critical path nodes that have both critical path predecessors and successors. The mechanism of the present invention uses greatest height/depth as primary and lowest slack as secondary, but will override this when highest priority node has slack greater than a threshold and a critical path node is available. LxMS will give non-critical path nodes that have both critical path predecessors and successors priority over critical path, whereas the invention does not. LxMS will give critical path nodes priority over a chain of non-critical path nodes even when they have very little slack, whereas the mechanism of the present invention will not give these types of node priority over a chain of critical path nodes.

Turning now to FIG. 6, a flowchart of a process for ordering nodes is depicted in accordance with a preferred embodiment of the present invention. The process illustrated in FIG. 6 may be implemented in a compiler, such as compiler 300 in FIG. 3. Specifically, the process illustrated in FIG. 6 may be implemented in step 504 in FIG. 5. This process is specifically when a loop is register-constrained. A loop may be identified as being register constrained if a schedule is found for a given initiation interval that respects instruction usage of data processing system resources and all latencies between nodes, but the schedule also uses more hardware registers than are available. Additionally, it is assumed that the modulo scheduling of a loop is performed on intermediate code using symbolic rather than hardware registers with register allocation occurring after scheduling.

The process begins by identifying the nodes available for selection (step 600). The nodes available for selection are those nodes that have not yet been placed into the prioritized ordering, and that are direct predecessors or successors of nodes that have been ordered. Next, the node with the highest priority is determined (step 602). When scheduling in the forward direction, the next highest priority node is select from the available nodes with the greatest height value. When scheduling in the backward direction, the next highest priority node is selected using the greatest depth value. If multiple nodes have the greatest height/depth value, then the lowest slack value is used to select between them. Next, a determination is made as to whether the selected node from step 602 has a slack greater than or equal to a slack threshold (step 604). This step determines if significant slack is present. The slack threshold is determined such that it balances between giving priority to critical path nodes over non-critical path nodes, and giving sufficient priority to non-critical path nodes that only have a little slack in the schedule. If the slack threshold is too high a value, then non-critical path nodes will sometimes be given too high a priority in the ordering, which can lead to longer than optimal schedule lengths. If the slack threshold is too low a value, then non-critical path nodes will often be ordered after critical path nodes, which can lead to a situation where a non-critical path node cannot be placed in the schedule because it has both predecessors and successors scheduled, and the only cycles it can be placed are full due to other instructions consuming machine resources.

If the slack is not greater than or equal to the slack threshold, the node is placed into the order (step 606). If a node is selected with highest priority in step 602, and it is determined that the slack value is lower than the slack threshold, then the node is added to the ordering because it does not have enough slack to have the flexibility to be ordered later. However, if the node does have a slack greater or equal to the threshold, then it has sufficient flexibility to be ordered later because it is likely that it can be scheduled between predecessors and successors successfully.

In selecting a node for ordering in which a node has successors or predecessors available for ordering, a node is selected with a maximum height in the forward direction or a maximum depth in the backward direction. If multiple nodes are available with equal height in the forward direction or depth in the backward direction, the process chooses a node with the lowest value of slack

Thereafter, predecessors and successors of the chosen node placed into the order are added to the list of nodes available (step 608).

Then, a determination is made as to whether any available nodes are left for placement into the order (step 610). If available nodes are present, the process returns to step 602. Otherwise, all of the nodes have been ordered and the process terminates.

With reference again to step 604, if the selected node does not have a slack greater or equal to than a slack threshold, then a determination is made as to whether a node in the list of available node is on a critical path (step 612). A node is considered to be on the critical path if the slack for the node is zero. If the node is not on a critical path, the process proceeds to step 606. On the other hand, if a node on the critical path is available, that node is selected for placement (step 614) with the process then proceeding to step 606 as described above.

The mechanism of the present invention chooses nodes with a zero slack over nodes with a relatively high slack, even when the height or depth is not as great. The effect of this selection is that the mechanism of the present invention selects orderings that favor the critical path over nodes that are not on the critical path. This type of selection is performed only when non-critical path nodes have sufficient slack that allows those nodes to be placed into the schedule between the predecessors and successors.

Thereafter, the selected node is placed into the order (step 608). Next, a determination is made as to whether additional nodes are present to order (step 610). If additional nodes are present, the process returns to step 604 as described above. Otherwise, the process terminates. In step 604, it is determined if there is an available node(s) that lies on the critical path, and if so the highest priority one of these based on height/depth is selected in step 614 as the new highest priority node. The highest priority node is then added to the ordering in box 606.

Turning back to step 604, if the selected node does not have slack that is greater than or equal to a slack threshold, the process then proceeds step 612 as described above.

The mechanism of the present invention is primarily beneficial in the situation where a loop is register-constrained. Thus, it is beneficial to detect this property of a loop. One method is to attempt to find a valid schedule for the loop using the normal swing modulo scheduling algorithm, and if it fails to find a schedule because more registers are used than are available, then the loop is register-constrained. However, in some cases (as will be seen in the example below), it can be beneficial to use the invention on certain loops to prevent generation of extra register copy instructions.

The present invention applies to the section of the ordering phase of swing modulo scheduling, when the next predecessor or successor to the currently ordered pool of nodes is being selected. The swing modulo scheduling ordering algorithm selects the next node to be ordered based on the maximum value for height in the forward direction, or the maximum value for depth in the backward direction.

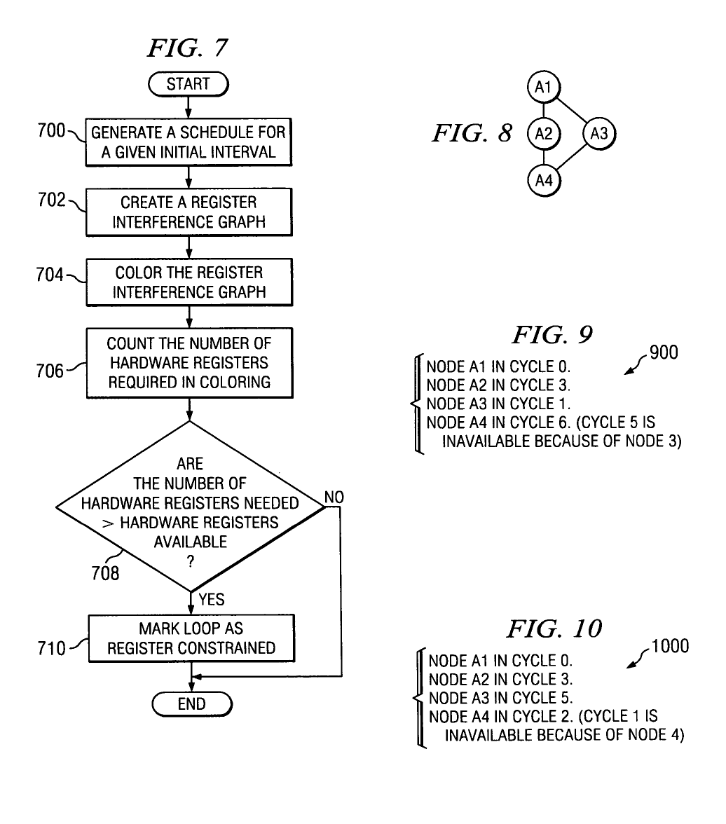

With reference now to FIG. 7, a flowchart of a process for identifying a registered constrained loop is depicted in accordance with a preferred embodiment of the present invention. The process illustrated in FIG. 7 may be implemented in a data processing system such as data processing system 200 in FIG. 2. This process is performed for a loop in the code.

The process begins by generating a schedule for a particular initiation interval (step 700). Next, a register interference graph is created (step 702). In step 702, a heuristic is used to determine how many hardware registers will be required for the completed schedule. In particular, step 702 generates a register interference graph and performs coloring on the graph to determine exactly how many registers are required. A register interference graph shows a table with each symbolic register as a row and each clock cycle as a column. Coloring is the method of finding which symbolic registers can be mapped to the same hardware register. This topic is a well-known technique for register allocation. Of course, any heuristic or other process may be used to identify the hardware registers. For example, a simpler heuristic is to just determine how many registers are in use at the end of each clock cycle, and take the maximum value as the number of registers required, but this method is not exact. This register interference graph is then colored (step 704). The number of hardware registers required in coloring the graph is identified (step 706). Step 706 is used to identify the number of hardware registers needed.

Next, a determination is made as to whether the number of hardware registers available is greater than the number of available hardware registers (step 708). If the number of hardware registers needed is greater than the number of hardware registers available, the loop is marked as being register constrained (step 710) with the process terminating thereafter. Otherwise, the process terminates without marking the loop.

Turning to FIG. 8, a data dependency graph is depicted in accordance with a preferred embodiment of the present invention. In this example, data dependency graph 800 is an example of a diagram containing nodes that may be placed into an order using the mechanism of the present invention. Currently available swing modulo scheduling algorithms may select an ordering of nodes as follows: node A1, node A2, node A3, and node A4. However, this could lead to a situation in which the total duration of the schedule is longer than necessary. Consider the case in which a processor can process 1 instruction per cycle, and the latencies (issue to issue) from node A1 to A2 is 3 cycles, and delay from node A2 to A4 is 2 cycles, while the delays from node A1 to A3 and A3 to A4 are 1 cycle each. If the ordering that swing modulo scheduling generates is A1, A2, A3, and A4, and the initiation interval of the schedule is 4 cycles, then the Swing modulo scheduling phase may select a schedule as shown in FIG. 9.

Turning to FIG. 9, a schedule generated by a known swing modulo scheduling algorithm is depicted. Schedule 900 shows a scheduling of nodes generated through a known swing modulo scheduling algorithm. Note that node A4 is now 5 cycles after node A3, which is a difference of more than 1 iteration of the loop. This situation means that if there is a register dependency between these instructions, then that register value must be kept alive across more than 1 iteration of the loop, requiring rotating registers (if available on the processor) or register copy instructions. Thus, this schedule in FIG. 9 would not be valid if register copy instructions were needed because the processor can only perform one instruction per cycle and all of the cycles are full.

Also note that this loop has a total duration from cycle 0 to cycle 6, or 7 cycles. Assuming all edges in the graph are register dependencies, then it would require 2 registers for the edge from 3 to 4, 1 register for the edge from 2 to 4, 1 register for the edge from 1 to 2, and 1 register for the edge from 1 to 3. The total register requirement would be 5 for this loop, including some need for rotating registers. This situation is far from optimal.

The present invention modifies the swing modulo scheduling ordering phase to give priority to nodes on the critical path over nodes that are not on the critical path. It does this by using the slack value already calculated by swing modulo scheduling when analyzing the data dependency graph. The present invention does not require the calculation of any additional information to proceed. When selecting the next predecessor/successor to add to the ordering, if the highest priority node has a slack value above some threshold and there also is one or more nodes on the critical path available for ordering, then the modified ordering algorithm selects the critical path node with highest priority.

In the example above, the critical path of the data dependency graph consists of the nodes A1, A2, and A4. These nodes have a slack value of 0, while node A3 has a slack value of 3. Thus, the modified ordering algorithm will still select nodes A1 and A2 to start the ordering. However, at this point it finds the node with the maximum height is 3, but it has a slack value of 3. It detects that node A4 is available for ordering and lies on the critical path of the data dependency graph, and selects it next since nodes A3's slack value of 3 is relatively high. It then orders node A3, so that the ordering is A1, A2, A4, and A3.

Turning to FIG. 10, a diagram illustrating scheduling of nodes from a data dependency graph is depicted in accordance with a preferred embodiment of the present invention. Schedule 1000 illustrates a schedule of nodes based on an ordering generated using the mechanism of the present invention. Note that node A4 is now only 2 cycles after node A2, and 3 cycles after node A3. This situation does not require rotating registers (or register copy instructions) for the register value between 3 and 4. The overall duration of the schedule is now only 6 cycles (cycle 0 to cycle 5). The number of registers required is just 4, corresponding to the 4 edges in the data dependency graph. This schedule is optimal in register usage and number of cycles.

In yet another example, the mechanism of the present invention may induce register pressure. In this illustrative example, a processor may process 1 instruction per cycle and latencies between all instructions are 3 cycles.

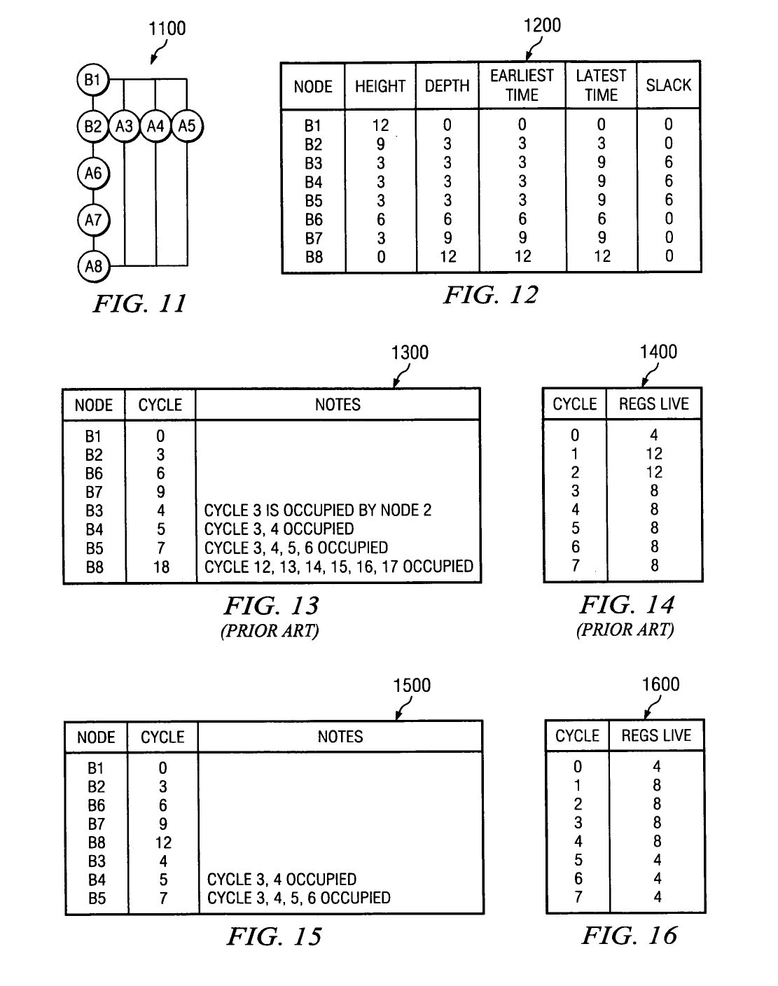

Turning now to FIG. 11, a data dependency graph is depicted in accordance with a preferred embodiment of the present invention. Data dependency graph 1100 is a diagram of a loop. Analysis of data dependency graph 1100 yields a number of properties including, for example, height, depth, earliest time, latest time, and slack. Height is a location of a node from the top while depth is a location of a node from the bottom of the diagram. Earliest time is defined as the earliest time a node in the data dependency graph could be placed in a schedule such that it respected all dependencies, such that the schedule was of minimum duration when not constrained by machine resource usage. In a similar manner, the latest time is the latest time a node could be placed in the schedule of minimum duration.

Turning now to FIG. 12, a diagram illustrating properties of nodes in a data dependency graph is depicted in accordance with a preferred embodiment of the present invention. In this example, table 1200 illustrates properties of nodes in data dependency graph 1100. Note that nodes B3, B4, and B5 have slack equal to 6, whereas the other nodes are on the critical path and have slack of 0. The Swing modulo scheduling algorithm would likely select an ordering of B1, B2, B6, B7, B3, B4, B5, and B8 for the nodes in this loop. The process would then try to find a schedule with initiation interval=8 (due to the resource constraint of 8 instructions, and the machine can process 1 per cycle).

Turning now to FIG. 13, a diagram illustrating a schedule generated through a known swing modulo scheduling algorithm is depicted. Schedule 1300 illustrates a schedule for nodes from data dependency graph 1100. Note that node B8 is more than 1 iteration away from its predecessors, which would require rotating registers or copy instructions to keep the register values alive. Also note the schedule is much longer than necessary, which makes it require more register than necessary. This schedule has live registers at the start of each cycle in FIG. 14. With reference to FIG. 14, a live register table is depicted from the schedule in FIG. 13. Live register table 1400 shows register that are live based on schedule 1300 in FIG. 13.

Using the mechanism of the present invention, an ordering of B1, B2, B6, B7, B8, B3, B4, and B5 is selected. The process then finds a schedule. Referring to FIG. 15, a diagram illustrating a schedule using an ordering process of the present invention is depicted. Schedule 1500 is an example of a schedule generated from an order selected by the mechanism of the present invention. This schedule does not have any values live longer than one iteration, and the process finds a schedule that is the same length as the duration of the graph, which is optimal in register usage. The schedule has registers live at the start of each cycle as shown in FIG. 16.

Next, FIG. 16 illustrates a live register table based on the schedule in FIG. 16 in accordance with a preferred embodiment of the present invention. Live register table 1600 is generated from schedule 1500 in FIG. 15.

Thus, the present invention provides an improved method, apparatus, and computer instructions for ordering nodes to generate a valid schedule for a loop when a loop is register-constrained. In other words, the mechanism of the present invention may be applied to loops in which the number of registers available is limited. The mechanism of the present invention places nodes into an order in which the ordering favors nodes on a critical path in a data dependency graph. In general, the invention is useful for loops that have nodes which have considerable slack, and that have both predecessors and successors. In this case, node 3 had both predecessors and successors, and had a relatively high slack value of 3. For our purposes, we can call this property “internal slack”. This means that node 3 is relatively easy to schedule, and should not be favored over nodes on the critical path when register usage must be minimized.

One potential negative aspect of the modified ordering algorithm is that it can create situations in which the node with internal slack cannot be scheduled. This occurs when it comes time to schedule the node with internal slack, but there are not enough machine resources to place the node in any of the possible cycles. However, this situation can easily be avoided by selecting a sufficiently high threshold for the slack value of the node for which the modified ordering algorithm will be used. In our example, the slack value of 3 was sufficiently high so that there were 4 possible cycles that node 3 could be placed (cycles 1, 2, 3, or 4). The optimal value for the slack threshold for which the invention should be used depends on the type of machine, and the nature of specific loops, and can be determined through experimentation.

Thus the invention solves the problem of less than optimal scheduling for many register-constrained loops without any significant increase in compile time cost.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for optimizing loops in code during swing modulo scheduling of the code, the method comprising:
identifying nodes available to select for placement in a set of ordered nodes to form available nodes for placement;
identifying a node with a highest priority to form an identified node;
determining whether the identified node has a slack greater than a threshold;
placing the identified node in the set of ordered nodes if the identified node does not have a slack greater than a threshold;
determining whether a critical path node on a critical path is present in available nodes if the identified node does not have the slack greater than the threshold;
responsive to a determination that the critical path node is present, selecting the critical path node for placement in the set of ordered nodes.

2. The method of claim 1 further comprising:
building a data dependency graph containing the nodes, wherein the data dependency graph includes a critical path having a longest chain of dependency.

3. The method of claim 1, wherein the node is a predecessor node to the last selected node.

4. The method of claim 1, wherein the node is a successor node to the last selected node.

5. The method of claim 1, wherein the method is performed during an ordering phase in the swing modulo scheduling by a compiler.

6. The method of claim 1, wherein lower register use results from code generated from the set of ordered nodes.

7. The method of claim 1, wherein the nodes are located in a loop.

8. A swing modulo scheduling process comprising:
identifying nodes for a loop from a data dependency graph available for ordering; and
ordering the nodes in which priority is given to nodes using slack as a primary factor and height/depth as a secondary factor unless the nodes have a slack greater than a threshold and a node on the critical path is available.

9. A data processing system for optimizing loops in code during swing modulo scheduling of the code, the data processing system comprising:
first identifying means for identifying nodes available to select for placement in a set of ordered nodes to form available nodes for placement;
second identifying means for identifying a node with a highest priority to form an identified node;
first determining means for determining whether the identified node has a slack greater than a threshold;
placing means for placing the identified node in the set of ordered nodes if the identified node does not have a slack greater than a threshold;
second determining means for determining whether a critical path node on a critical path is present in available nodes if the identified node does not have the slack greater than the threshold;
selecting means, responsive to a determination that the critical path node is present for selecting the critical path node for placement in the set of ordered nodes.

10. The data processing system of claim 9 further comprising:
building means for building a data dependency graph containing the nodes, wherein the data dependency graph includes a critical path having a longest chain of dependency.

11. The data processing system of claim 9, wherein the node is a predecessor node to the last selected node.

12. The data processing system of claim 9, wherein the node is a successor node to the last selected node.

13. The data processing system of claim 9, wherein the data processing system is performed during an ordering phase in the swing modulo scheduling by a compiler.

14. The data processing system of claim 9, wherein lower register use results from code generated from the set of ordered nodes.

15. The data processing system of claim 9, wherein the nodes are located in a loop.

16. A swing modulo scheduling process comprising:
identifying means for identifying nodes for a loop from a data dependency graph available for ordering; and
ordering means for ordering the nodes in which priority is given to nodes using slack as a primary factor and height/depth as a secondary factor unless the nodes have a slack greater than a threshold and a node on the critical path is available.

17. A computer program product in a computer readable medium for optimizing loops in code during swing modulo scheduling of the code, the computer program product comprising:
first instructions for identifying nodes available to select for placement in a set of ordered nodes to form available nodes for placement;
second instructions for identifying a node with a highest priority to form an identified node;
third instructions for determining whether the identified node has a slack greater than a threshold;
fourth instructions for placing the identified node in the set of ordered nodes if the identified node does not have a slack greater than a threshold;
fifth instructions for determining whether a critical path node on a critical path is present in available nodes if the identified node does not have the slack greater than the threshold;
sixth instructions responsive to a determination for selecting the critical path node for placement in the set of ordered nodes.

18. The computer program product of claim 17 further comprising:
seventh instructions for building a data dependency graph containing the nodes, wherein the data dependency graph includes a critical path having a longest chain of dependency.

19. The computer program product of claim 17, wherein the node is a predecessor node to the last selected node.

20. The computer program product of claim 17, wherein the node is a successor node to the last selected node.

21. The computer program product of claim 17, wherein first instructions, second instructions, third instructions, fourth instructions, fifth instructions, and sixth instructions are performed during an ordering phase in the swing modulo scheduling by a compiler.

22. The computer program product of claim 17, wherein lower register use results from code generated from the set of ordered nodes.

23. The computer program product of claim 17, wherein the nodes are located in a loop.

24. A computer program product in a computer readable medium for a swing modulo scheduling process, the computer program product comprising:
first instructions for identifying nodes for a loop from a data dependency graph available for ordering; and
second instructions for ordering the nodes in which priority is given to nodes using slack as a primary factor and height/depth as a secondary factor unless the nodes have a slack greater than a threshold and a node on the critical path is available.

25. A data processing system for optimizing loops in code during swing modulo scheduling of the code, the data processing system comprising:
a bus system;
a communications unit connected to the bus system;
a memory connected to the bus system, wherein the memory includes a set of instructions; and
a processing unit connected to the bus system, wherein the processing unit executes the set of instructions to identify nodes available to select for placement in a set of ordered nodes to form available nodes for placement; identify a node with a highest priority to form an identified node; determine whether the identified node has a slack greater than a threshold; place the identified node in the set of ordered nodes if the identified node does not have a slack greater than a threshold; determine whether a critical path node on a critical path is present in available nodes if the identified node does have not the slack greater than the threshold; and select the critical path node for placement in the set of ordered nodes in response to a determination that the critical path node is present.

26. A data processing system in a swing modulo scheduling process comprising:
a bus system;
a communications unit connected to the bus system;
a memory connected to the bus system, wherein the memory includes a set of instructions; and
a processing unit connected to the bus system, wherein the processing unit executes the set of instructions to identify nodes for a loop from a data dependency graph available for ordering; and order the nodes in which priority is given to nodes using slack as a primary factor and height/depth as a secondary factor unless the nodes have a slack greater than a threshold and a node on the critical path is available.
